(19) United States
(12) Patent Application Publication
(10) Pub. No.: US 2015/0289069 A1
(43) Pub. Date: Oct. 8, 2015

(54) HEARING AID DEVICE

(71) Applicant: Oticon A/S, Smorum (DK)

(72) Inventor: Henning Knak POULSEN, Roskilde (DK)

(73) Assignee: OTICON A/S, Smorum (DK)

(21) Appl. No.: 14/677,120

(22) Filed: Apr. 2, 2015

(30) Foreign Application Priority Data
Apr. 3, 2014 (EP) 14163355.2

(51) Int. Cl. H04R 25/00; H04R 31/00

(52) U.S. Cl. CPC H04R 25/652; H04R 31/00; H04R 2225/023

(57) ABSTRACT

A hearing aid device comprises a body member having a through-going canal and a receiver comprising means for attaching a dome. The device comprises a pull out string for inserting the body member in an ear canal and to pull out the body member from the ear canal. The device comprises a pull out string displaceable arranged within a pull out string canal of the body member. The pull out string comprises a through-going bore and the device comprises means for maintaining the pull out string in a first position within the pull out string canal, where in a first position the through-going canal and the through-going bore constitute a through-going vent while inserting the body member into the ear canal. The device comprises means for bringing and maintaining the pull out string into a second position, where in a second position the pull out string blocks the through-going canal.

### FIELD

The present disclosure generally relates to a hearing device having a receiver configured to be inserted into the ear canal of a hearing aid user. The present disclosure more particularly relates to a hearing device, which is easy to insert into and remove from the ear canal and that is comfortable to wear.

### DESCRIPTION OF THE RELATED ART

When using hearing aid devices such as receiver-in-the-ear (RITE), completely-in-canal (CIC) and invisible-in-canal (IIC) hearing aid devices mounted within the bony part of the ear, the hearing aid user experiences a negative pressure in the space between the dome and the ear drum when the hearing aid device is removed from the ear canal when the hearing aid device is sealingly mounted within the ear canal. Accordingly, a vent is often provided to eliminate the pressure difference across the dome. The use of a vent is, however, associated with the undesired phenomena known as acoustic feedback caused by the leakage of sound from the receiver back to the microphone.

Therefore, it would be desirable to have a hearing aid device in which building up a negative pressure in the space between the dome and the ear drum when the hearing aid device is removed from the ear canal may be eliminated.

WO 2012/149970 describes a venting means of an open fitted ear mould which are arranged at the medial end of the ear mould comprising a switch or valve like element, integrated in the ear mould being manually operable for opening or closing the venting means.

WO 2012/007067 describes an ear piece for insertion and placement in the ear canal in close vicinity of the ear drum. The ear piece comprises an inflatable balloon configured to be selectively inflated and deflated (e.g. when the ear piece needs to be withdrawn from the ear canal).

U.S. Pat. No. 4,905,322 describes an earcup assembly for insulating the ear of a wearer from ambient sound while inhibiting the transmission to the wearer's head through the assembly of shocks of impact from severe bumps. The earcup comprises a discrete hollow rigid cup-shaped crushable shell. The shell comprises a material having properties and such a thickness as to maintain its rigidity in ordinary use and to collapse upon impact from such severe bumps. The use of a material having a temperature dependent stiffness and thus being able to soften in response to body heat when the assembly is donned is described.

When using these prior art hearing aid devices the users may still experience certain discomfort either when the hearing aid has been inserted or during pulling out the hearing aid or experience other difficulties cause by the complexity of the vent mechanism. Thus, there is need for a hearing aid device that is comfortable to wear, easy to insert into and remove from the ear without creating discomfort for the user.

Accordingly, the present disclosure provides a hearing aid device, which is comfortable to wear, and that may easily be inserted into and be removed from the ear canal without causing discomfort for the hearing aid user.

### SUMMARY

The disclosure is achieved by a hearing aid device as defined in claim 1. Preferred embodiments are defined in the dependent sub claims and explained in the following description and illustrated in the accompanying drawings.

According to an embodiment of the disclosure, a hearing aid device comprises a body member comprising a through-going canal and a receiver comprises means for attaching a dome. The hearing aid device also comprises a pull out string. The pull out string functions as means for inserting the body member into an ear canal, and/or to pull out the body member from the ear canal. In the hearing aid device, the pull out string is displaceably arranged within a pull out string canal of the body member, wherein the pull out string comprises a through-going bore. The hearing aid device comprises means for maintaining the pull out string in a first position, while inserting the body member into the ear canal. In the first position, the pull out string canal, the through-going canal and the through-going bore constitute a through-going vent. The hearing aid device comprises means for bringing and maintaining the pull out string into a second position, in which second position the pull out string blocks the through-going canal.

In the present context, a “hearing aid device” refers to a device, such as e.g. a hearing aid, a listening device or an active ear-protection device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears.

A “hearing aid device” further refers to a device such as an earphone or a headset adapted to receive audio signals electronically, possibly modifying the audio signals and providing the possibly modified audio signals as audible signals to at least one of the user's ears.

A hearing device may comprise a single unit or several units communicating electronically with each other.

More generally, a hearing aid device comprises an input transducer for receiving an acoustic signal from a user's surroundings and providing a corresponding input audio signal and/or a receiver for electronically receiving an input audio signal, a signal processing circuit for processing the input audio signal and an output means for providing an audible signal to the user in dependence on the processed audio signal.

Some hearing aid devices may comprise multiple input transducers, e.g. for providing direction-dependent audio signal processing. In some hearing devices, the receiver may be a wireless receiver. In some hearing devices, the receiver may be e.g. an input amplifier for receiving a wired signal.

The hearing aid device may comprise an amplifier that constitutes the signal processing circuit.

The term body member is understood as a housing, which comprises a receiver, but may also comprise a battery, a microphone, the audio signal processing electronics including an amplifier, and the loudspeaker. The body member is inserted in the ear canal of the hearing aid user.

The body member has two ends; a first end and a second end. When the hearing aid device is inserted into the ear canal of the hearing aid user, the first end is closer towards the ear lobe in comparison to the second end, whereas the second end is closer towards the eardrum in comparison to the first end. The dome is attached to the second end of the body member, so that the hearing aid device is comfortable to wear for the hearing aid user. The dome may be any kind of dome, such as open domes, closed domes, double domes, power domes or tulip domes.

A through-going canal is provided in the body member. The term through-going canal is understood as a canal, which extends from the first end of the body member to the second end of the body member.

The canal has an opening both at the first end and at the second end of the body member. The through-going canal comprises means for opening and closing the canal. When the through-going canal is open, air can be guided through the canal; whereas when the through-going canal is closed, then no air can pass through the canal.

It may be useful to open the through-going canal when the hearing aid device is inserted into the ear canal of the user or when the hearing aid device is removed from the ear canal of the user. By inserting the hearing aid device into the ear canal of the hearing aid user, an overpressure is accumulating in the confined space between the dome of the hearing aid device and the eardrum. Opening of the through-going canal makes it possible to remove this overpressure, and thereby make it more comfortable to wear the hearing aid device for the user.

It may be advantageous to close the through-going canal, when the hearing aid device is inserted in the ear of the user. If the through-going canal is open while wearing the hearing aid user sound can be guided through the canal. This may cause acoustic feedback causing inconvenience for the hearing aid user.

It may be beneficial to open the through-going canal when removing the hearing device from the ear. By removing the hearing aid device that is sealingly arranged within the ear canal, a negative pressure is build up in the confined space between the dome and the eardrum, thus making it uncomfortable for the user to remove the hearing aid device. When opening the through-going canal during removal of the hearing aid device, it is possible for air to flow from the surroundings through the through-going canal and into the confined space between the dome and the eardrum thereby equalising the pressure inside the confined space with the surroundings.

The hearing aid device user can operate the pull out string in a manner in which pulling at the pull out string opens the through-going canal, whereas pushing at the pull out string closes the through-going canal. The term pull out string is understood as a string, which is connected to both the body member and the through-going canal, and protrudes from the body member in such a manner that the user can access the pull out string when the hearing aid device has to be inserted into the ear canal or be removed from the ear canal.

The pull out string may have any suitable shape, but may advantageously be rod-shaped. The pull out string has two ends, a proximal end and a distal end. The proximal end is arranged inside the body member and is connected to the through-going canal, whereas the distal end protrudes from the hearing aid device. A knob may be placed at the tip of the distal end of the pull out string.

The knob allows the user to easily operate the pull out string. The proximal end of the pull out string comprises a through-going bore, and at least one enlarged portion. The end portion of the pull out string functions as a stop portion, such that the pull out string cannot be pushed further inside the body member. Advantageously, next to the end of the pull out string a through-going bore is provided. Beneficially, the at least one enlarged portion is arranged between the through-going bore and the distal end of the pull out string.

By the term through-going bore is understood a bore, that extends through the pull out string. The through-going bore may have any suitable shape, but have preferably a cylindrical shape. The through-going bore may extend basically perpendicular to the longitudinal axis of the pull out string.

When the hearing aid user pulls at the pull out string, the through-going canal and the through-going bore constitute a through-going vent, which makes it possible for air and sound to flow through the through-going canal.

The pull out string comprises at least one enlarged portion. Advantageously the pull out string comprises at least two enlarged portions. Advantageously, the at least one enlarged portion is arranged between the through-going bore and the distal end of the pull out string.

By the term enlarged portion is meant a portion which is enlarged, in such a manner that it has a larger cross-section width than the width of the pull out string. The enlarged portion may have any suitable geometrical shape, but preferably has a round cross-section. If several enlarged portions are provided at the pull out string, these enlarged portions may be arranged adjacent to each other.

The pull out string is slidably mounted within a pull out string canal of the body member in. By the term pull out string canal is understood a canal that is provided inside the body member.

The pull out string canal comprises at least two groove members, an open end and a closed end wherein the open and closed ends are opposite each other. The pull out string canal is in fluid communication with the through-going canal. The through-going canal and the pull out string canal are configured to be brought into fluid communication, so that the through-going canal has a portion that extends basically perpendicular on the pull out string canal.

By the term “basically perpendicular” is meant that the angle between the through-going canal and the pull out string canal is around 90 e.g. in the range 80-100°.

The term groove member is understood as a portion having a larger cross-section width than the width of the pull out string. The groove member may have any suitable geometrical shape, but it may be an advantage that is has a round (circular) cross-section.

The pull out string canal has at least two groove members. Beneficially, the pull out string canal has two groove members. However, the pull out string canal may have three groove members.

If two or more groove members are arranged within the pull out string canal, these groove members may advantageously be arranged adjacent to each other.

The number of groove members of the pull out string canal may be one number higher than the number of the enlarged portion(s). It is beneficial, that the pull out string comprises one enlarged portion and that the pull out string canal comprises two groove members. On the other hand, the pull out string may comprise two enlarged portions and the pull out string canal may comprise three groove members.

The at least one enlarged portion provided on the pull out string and the at least two groove members provided within the pull out string canal are constructed in such a manner that the geometrical shape of the groove member fits the geometrical shape of the enlarged portion. The groove member and the enlarged portion may engage partly or completely.

Beneficially, if the pull out string comprises two enlarged portions; a first and a second enlarged portions, and the pull out string canal comprises three groove members; a first, a second and a third groove members. Then the first enlarged portion is fitted into the first and second groove members, whereas the second enlarged portion is fitted into the second and third groove members.

According to an embodiment, a hearing aid device comprising a body member having a receiver comprising means for attachment of a dome and a through-going canal, where the hearing aid device comprises a pull out string for inserting the body member into an ear canal and to pull out the body member from the ear canal, where the hearing aid device comprises a pull out string displaceably arranged within a pull out string canal of the body member, where a spring is arranged in the pull out string canal in such a manner that the pull out string can be displaced such that the through-going canal is open by either pulling or pushing the pull out string.

In this embodiment, the pull out string canal comprises an open end and a closed end. Advantageously, the open and closed ends are opposite each other.

The spring may be provided in the closed end of the pull out string canal. Advantageously, the open end is constructed such that it fits with the size of the pull out string. The pull out string canal may be in fluid communication with the through-going canal. The through-going canal may comprise a portion that extends basically perpendicular to the pull out string canal. By the term “basically perpendicular” is meant that the angle between the through-going canal and the pull out string canal is about 90°, such as 80-100°.

It may be an advantage that the pull out string comprises a stop portion arranged within the pull out string canal in such a manner that the stop portion blocks the through-going canal, when the spring is in its resting position.

Hereby it is achieved that ventilation is established when the pull out string is activated (pulled or pushed) and that the through-going canal is blocked when no force is applied to the pull out string.

The proximal end of the pull out string may comprise a through-going bore and a stop portion. The stop portion may be an integrated part of the pull out string or be mechanically attached to the pull out string. A spring may be attached to the closed end of the pull out string canal and or to the stop member. When the spring is in its resting position the stop portion will block the through-going canal, so that no air can be guided through the through-going canal.

If the pull out string is pulled the spring will be elongated facilitating an air flow through the through-going canal.

On the other hand, if the pull out string is displaced into the body member the spring will be compressed and the stop portion will be displaced further into the through-going canal. This will facilitate flow of air through the through-going canal.

The term stop portion may be of any suitable shape and size as long as it is suitable for preventing air to flow through the through-going canal by arranging the stop in a position in which it blocks the through-going canal. The stop portion may advantageously a width, which is wider than the width of the pull out string. This may beneficial when the open end of the pull out string canal corresponds to the size of the pull out string, because it may prevent the pull out string from being pulled out of the pull out string canal of the hearing aid device.

It may be an advantage that a spring is attached to both the pull out string and the pull out string canal.

The disclosure may be implemented by a hearing aid device comprising a body member having a receiver comprising means for attachment of a dome and a pull out string canal, where the hearing aid device comprises a pull out string for inserting the body member into an ear canal and to pull out the body member from the ear canal, where the hearing aid device comprises a pull out string displaceably arranged within a pull out string canal of the body member, where the dome comprises a vent opening member and an elastic and/or displaceable portion, and where the pull out string is mechanically attached to the elastic and/or displaceable portion, and where the vent opening member comprises means for being closed when no force is applied to the pull out string, and that the vent opening member comprises means for being brought into an open configuration by applying a force to the pull out string.

Hereby it is achieved that ventilation can easily be provided by pulling the pull out string. Moreover, ventilation may be prevented when no force is applied to the pull out string.

By the term vent opening member is meant as a valve-like member adapted to open or close. In the open position, air may be guided through the vent opening into the through-going canal in the body member. By opening the vent opening member it is possible to equalise the pressure in the confined space between the dome and the eardrum during insertion or removal of the hearing aid device. The vent opening member is attached to an elastic and/or displaceable portion.

By the term elastic and/or displaceable portion is meant an area, which is elastic and/or displaceable. The elastic and/or displaceable area is a portion of the dome. The elastic and/or displaceable area is may be an integrated portion of the dome or be a portion attached to the dome.

Advantageously, the elastic portion is more elastic than the remaining portion of the dome. By elastic is meant a material which has a higher elastic modulus than the elastic modulus of the material of the pull out string and/or the material of the dome. By displaceable is meant a material, which is able to be moved from its original position to the new position. Both the elastic and/or the displaceable material is able to open or close the vent opening member, when the pull out string is being operated.

Operating the pull out string controls the opening and closing of the vent opening member. Pulling at the pull out string will cause stretching of the elastic and/or displacement of the displaceable material in such a manner that the vent opens.

When the vent is open, it can be closed by either letting go of the pull out string or pushing the pull out string into the hearing aid device. The elastic and displaceable material will then retain its original length and position. The elastic and/or displaceable portion may be attached to the pull out string by any suitable mechanical means.

The mechanical attachment may be established by attaching the pull out string to the elastic and/or displaceable area by either a thread, screw fastening, riveting, melting or adding an adhesive. It may be an advantage that the mechanical attachment is an adhesive such as glue. It may be beneficial that the pull out string and the elastic and/or displaceable area is melted together.

The disclosure may be implement by a dome such as a tulip dome for a hearing aid device, where the dome comprises a first portion and a second portion, where the dome comprises means for creating a gap between the first portion and the second portion due to rotation of the dome while being mounted within the ear canal, where an adhesive is provided to the first portion and/or to the second portion.

Hereby it is possible to provide an easy way of providing ventilation during insertion and/or removal of a hearing aid into the ear canal of a hearing aid user.

The hearing aid device may comprise a body member having a receiver provided with means for attachment of the dome.

The dome may have a shape of a tulip, i.e. a tulip dome and comprises a first portion and a second portion. Advantageously, the two portions are thin walled sheets. Advantageously, the first portion is overlapping the second portion at the edges. The tulip dome may be designed to make a better fit in the ear canal, so that the dome is comfortable to wear for the user. It may be beneficial that an adhesive is provided at the outer surface of the dome and that the adhesive is configured to firmly attach the tulip dome in the ear canal of the hearing aid user when the hearing aid has been inserted into the ear canal.

It may be advantageous that the dome is shaped in such a way that by providing a slight rotation of the dome (e.g. before removal of the hearing aid device in the ear) an air gap will be provided the dome.

By providing a gap, it is possible to remove the hearing aid device from the ear without discomfort for the user because the pressure in the confined space, between the dome and the eardrum, and the surroundings are equalised.

The dome such as a tulip dome, can only produce a gap in the ear canal, because of the adhesive provided at the outer side of the dome. Adhesive added to the dome ensures that the outer portion is adhered to the skin portion of the ear canal. The portion that is attached to the ear canal will be stationary when a rotation is of the dome is initiated (due to the adhesive). When rotating the dome, the other portion of the dome will be rotated relative to the attached to the ear canal. Hereby a gap is provided between the portions of the dome.

It is useful, that the adhesive can only adhere at a temperature at or above 30° C. Hereby it is achieved, that the adhesive does not adhere when the dome is not inserted in the ear or when the dome is removed from the ear.

It may be beneficial; that the adhesive adhere to the skin portion of the ear canal, but the adhesive is not sufficiently strong to damage the skin portion during removal of the tulip dome from the ear canal. Hereby it is achieved, that the adhesive can adhere to the skin portion, but can also safely be removed from the ear without any discomfort for the user.

It is advantageous, that the adhesive can only adhere at a high humidity. By the term “high humidity” is meant humidity in the range that would be present in the ear. Hereby it is achieved, that the adhesive does not adhere when the tulip dome is not inserted in the ear or when the tulip dome is removed from the ear, but is only adhering in the ear.

It is beneficial, that the adhesive can only adhere at temperatures at or above 30° C. and at humidity within the range that would be present in the ear. Hereby it is achieved, that the adhesive does not adhere when the tulip dome is not inserted in the ear or when the tulip dome is removed from the ear, but is only adhering in the ear.

### BRIEF DESCRIPTION OF THE DRAWINGS

The disclosure will become more fully understood from the detailed description given herein below. The accompanying drawings are given by way of illustration only, and thus, they are not limitative of the present disclosure. In the accompanying drawings:

FIG. 1 a) schematically illustrates a view of an ear of a hearing aid user;

FIG. 1 b) illustrates a schematic close-up view of a hearing aid device shown in FIG. 1 a); FIG. 1 c) illustrates a cross-sectional view of the hearing aid device where air can flow through a through-going canal and FIG. 1 d) illustrates a cross-sectional view of the hearing aid device with the through-going canal not functioning as a vent, according to an embodiment of the disclosure;

FIG. 2 illustrates close-up views of the hearing aid device, where FIG. 2a) illustrating the through-going canal in closed position and FIG. 2b) illustrating the through-going canal in an open position, according to an embodiment of the disclosure;

FIG. 3 illustrates different views of a hearing aid device according to the disclosure, wherein FIG. 3 a) illustrates a schematic view of a closed vent member, FIG. 3 b) illustrates a schematic view of an open vent member, FIG. 3 c) illustrates a dome comprising a closed vent member, and FIG. 3 d) illustrates a dome comprising an open vent member, according to an embodiment of the disclosure;

FIG. 4 illustrates three cross-sectional views of a hearing aid device according to an embodiment of the disclosure, where FIG. 4 a) illustrates the through-going canal is closed by the stop portion, FIG. 4 b) illustrates the through-going canal being open, FIG. 4 c) illustrates the through-going canal being open, according to an embodiment of the disclosure;

FIG. 5 illustrates a cross-sectional view exploded of a hearing aid device, according to an embodiment of the disclosure;

FIG. 6 a) illustrates a tulip dome and FIG. 6 b) illustrates a schematic view of a hearing aid device according to the disclosure, according to an embodiment of the disclosure;

FIG. 7 a) illustrates a cross sectional view of a tulip dome being inserted into the ear canal and FIG. 7 b) illustrates a cross sectional view of a tulip dome, according to an embodiment of the disclosure; and

FIG. 8 a) illustrates a cross-sectional view of a hearing aid device and 8 b) illustrates a cross-sectional close-up view of the central portion of the hearing aid device shown in FIG. 8 a), according to an embodiment of the disclosure.

### DETAILED DESCRIPTION

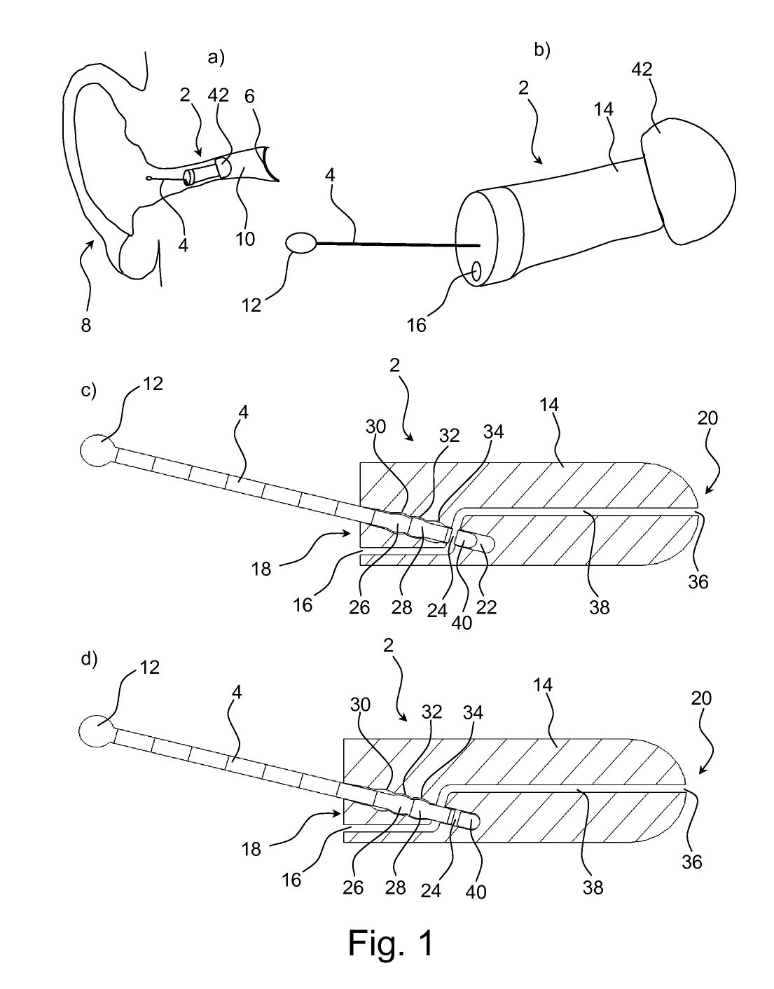

Referring now in detail to the drawings for the purpose of illustrating preferred embodiments of the present disclosure a hearing aid device 2 according to an embodiment of the disclosure is illustrated in FIG. 1 a).

FIG. 1 a) schematically illustrates a view of an ear 8 of a hearing aid user. A hearing aid device 2 is arranged in the ear canal 10. The hearing aid device 2 comprises a body member 14. The body member 14 includes a housing, which comprises a battery, a microphone, audio signal processing electronics including an amplifier, and the loudspeaker.

A dome 42 is attached to the body member 14 at its second end 20. The dome 42 makes the hearing aid device comfortable to wear the hearing aid device 2 for the hearing aid user. The second end 20 of the body member 14 is arranged close to the eardrum 6, whereas, the first end 18 is placed closer to the ear lobe and away from the eardrum 6 in comparison to the second end 20.

A pull out string 4 is inserted in the hearing aid 2 and protrudes from its first end 18. At the distal end of the pull out string 4, a knob 12 is provided. The user of the hearing aid can adjust the pressure in the confined space of the ear canal 10 between the dome 42 and the eardrum 6, by pulling or pushing at the knob 12.

When a hearing aid user inserts the hearing aid device 2 into the ear 8, an overpressure is provided in the confined space between the dome 42 and the ear drum 6. This overpressure is uncomfortable for the user. To remove the overpressure in the confined space, the pull out string 4 can be pulled in the direction towards the ear lobe and the air can flow from the confined space, between the dome 42 and the eardrum 6, through the opening 36 and into the through-going canal 38, and through the through-going bore 24 and out through the opening 16.

When the hearing aid device 2 is inserted in the ear canal 10 and no overpressure is present in the confined space the through-going canal 38 needs to be closed in order to prevent unwanted noise (acoustic feedback). To close the through-going canal 38, the pull out string 4 is pushed in the direction towards the eardrum 6. Pushing the pull out string 4 closes the through-going bore 24, so that air leakage can be prevented.

FIG. 1 b) illustrates a schematic close-up view of a hearing aid device 2 shown in FIG. 1 a). The hearing aid device 2 has a body member 14 having a dome 42 attached to it. A pull out string 4 is protrudes from the end of the body member 14. At the same end, an opening is provided 16.

FIG. 1 c) and FIG. 1 d) illustrates cross-sectional views of the hearing aid device 2 shown in FIG. 1 a) and FIG. 1 b). The body member 14 has a first end 18 and a second end 20. A first opening 16 is provided at the first end 18 and a second opening 36 is provided at the second end 20.

The two openings 16 and 36 are connected by a through-going canal 38. The through-going canal 38 makes it possible to ventilate the hearing aid device 2. However, it is not optimal to have a constant opening in the hearing aid device 2 due to the risk of acoustic feedback. A pull out string 4 is therefore slidably attached to the body member 14 of the hearing aid device 2 to regulate the airflow through the through-going canal 38 and thus the pressure in the ear canal 10 and in the space between the hearing aid device 2 and the eardrum 6.

The pull out string 4 comprises at its distal end a knob 12. The user of the hearing aid device 2 can regulate the position of the pull out string 4 by pushing or pulling at the knob 12. The proximal end 40 of pull out string 4 is arranged close to the blind end of the pull out string canal 22.

Two enlarged portions 26, 28 are provided adjacent to each other at the proximal end of the pull out string 4. The first enlarged portion 26 is placed further away from the end 40 of the pull out string 4 in comparison to the second enlarged portion 28 and the second enlarged portion 28 is placed closer to the end 40 of the pull out string 4 in comparison to the first enlarged portion 26. A through-going bore 24 is provided at the proximal end of the pull out string 4. The through-going bore 24 is cylindrical and has the length of the width of the pull out string 24.

The pull out string canal 22 has three groove members; a first groove member 30, a second groove member 32 and a third groove member 34. The pull out string canal 22 is arranged within the through-going canal 38 in a manner in which the two canals (pull out string canal and through-going canal) extend basically perpendicular on each other.

The first enlarged portion 26 fits into the first groove member 30 and the second groove member 32. The second enlarged portion 28 fits into the second groove member 32 and the third groove member 34.

As illustrated in FIG. 1 c) the through-going bore 24 is in alignment with the through-going canal 38 such that air can flow through the through-going canal 38. Opening of the through-going canal 38 is advantageous when the hearing aid device 2 is either inserted into or removed from the ear canal of the hearing aid user. Opening of the through-going canal 38 makes it possible to equalise the pressure in the confined space 56, in the ear canal 10 between the hearing aid device 2 and the eardrum 6.

When the through-going bore 24 is aligned with the through-going canal 38 so that air can flow through the through-going canal 38, the first enlarged portion 26 is fitted into the first groove member 30 and the second enlarged portion 28 is fitted into the second groove member 32. When the through-going canal 38 is open an empty space is provided between the end 40 of the pull out string 4 and the blind end of the pull out string canal 22.

In FIG. 1 d) the through-going bore 24 is not in alignment with the through-going canal 38. Accordingly, the through-going canal 38 will not function as a vent. It may be an advantage to close the through-going canal 38 when the hearing aid device 2 has been inserted into the ear canal 8 of the user, since closing the through-going canal 38 prevents acoustic feedback.

In FIG. 1 d) the through-going bore 24 is not aligned with the through-going canal 38. The end 40 of the pull string 4 is arranged within and received by the end of the pull out string canal 22. The through-going bore 24 is arranged in a position in which air from the through-going canal 38 is prevented from passing through the through-going bore 24 of the pull string 4.

The through-going canal 38 is blocked by the pull out string 4 and the first enlarged portion 26 is fitted into the second groove member 32 and the second enlarged portion 28 is fitted into the third groove member 34.

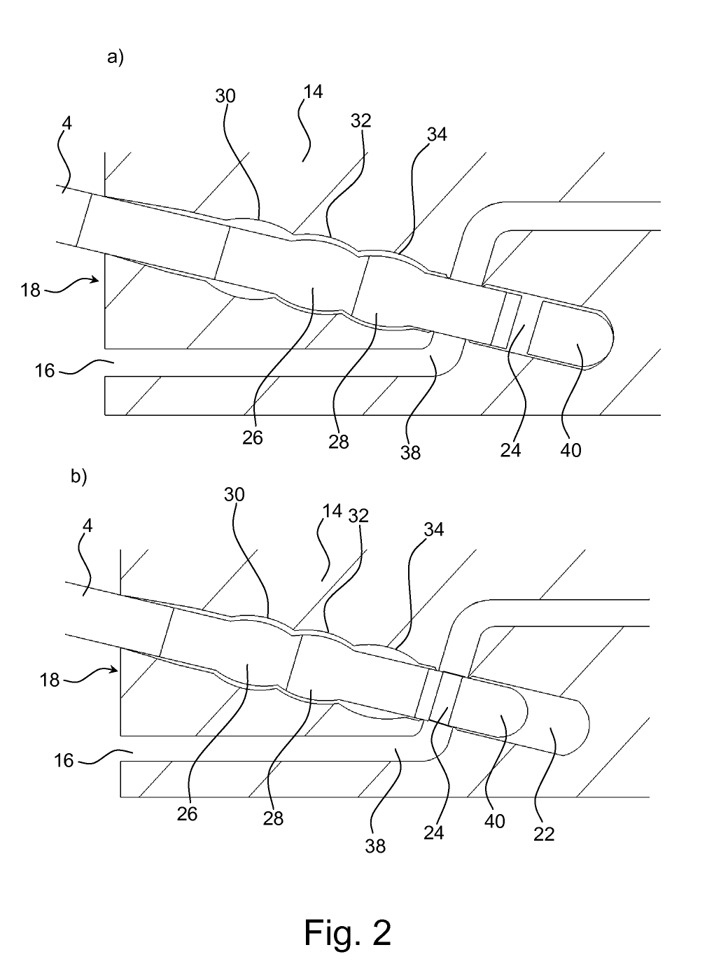

FIG. 2 illustrates a schematic close-up cross-sectional view of the opening and closing mechanism of the embodiment shown in FIG. 1.

To open the through-going canal 38 (as shown in FIG. 2 b) from the closed position (as shown in FIG. 2 a) it is necessary to pull at the pull out string 4. By pulling at the pull out string 4, the first enlarged portion 26 is moved from the second groove member 32 to the first groove member 30 and the second enlarged portion 28 is moved from the third groove member 34 to the second groove member 32. By pulling at the pull out string 4, it aligns the through-going bore 24 with the through-going canal 38, which makes it possible for air to flow through the through-going canal 38.

If the user of the hearing aid device further pulls at the pull out string 4, then it is impossible for the pull out string 4 to move in the pull out string canal 22 and the hearing aid device 2 can therefore be pulled out of the ear 8 by pulling at the pull out string 4.

To close the through-going canal 38 (as shown in FIG. 2 a) from the open position (as shown in FIG. 2 b) when the hearing aid device 2 has been inserted in the ear 8 of the user, it is necessary push the knob 12 of the pull out string 4 towards the eardrum 6 of the user. The first enlarged portion 26 is then displaced from a position within the first groove member 30 to a position within the second groove member 32. The second enlarged portion 28 is then displaced from a position within the second groove member 32 into a position within the third groove member 34.

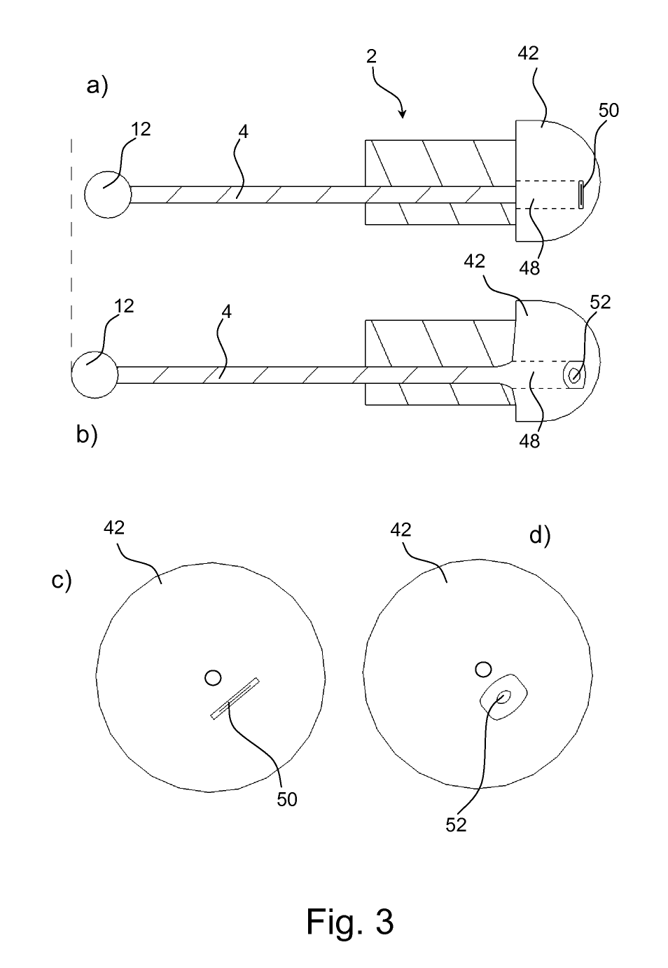

FIG. 3 illustrates a schematic view of a closed vent member 50 (FIG. 3 a) and an open vent member 52 (FIG. 3 b) of a hearing aid device 2 according to an embodiment of the disclosure. The hearing aid device 2 comprises a body member and a pull out string 4 provided with a knob 12 at its distal end.

The knob makes it easier for the user of the hearing aid device 2 to operate the pull out string 4 and thereby close or open the vent member 50, 52. A dome 42 is attached to the hearing aid device 2 at its distal end. An elastic and/or displaceable area 48 made of an elastic and/or displaceable material is provided at the dome 42.

FIG. 3 a) illustrates the hearing aid device 2 in a configuration in which the vent member 50 is closed, whereas FIG. 3 b) shows the hearing aid device in a configuration, in which the vent member 52 is open.

The position of the pull out string 4 determines whether the vent member 50, 52 is open or closed. The pull out string 4 is arranged placed in a pull out string canal within the body member of the hearing aid device 2. If the user of the hearing aid pulls in the knob 12 of the pull out string 4, then the pull out string 4 pulls in the elastic and/or displaceable material and the vent opens 52 (like shown in FIG. 3 b). Opening of the vent 52 makes it possible for air to flow through the vent and into the hearing aid device. It is possible for the user of the hearing aid to close the vent 50 again, by letting go of the pull out string 4 if the area 48 is an elastic area 48 (the area 48 will contract and regain its original length and herby pull back the pull out string 4). Otherwise, the pushing the pull out string 4 may be manually pushed back towards the dome 42.

FIG. 3 c) and FIG. 3 d) illustrate a top view of the domes 42 shown in FIG. 3 a) and in FIG. 3 b). FIG. 3 c) shows a dome 42 comprising a closed vent member 50, whereas FIG. 3 d) shows the dome 42 with the vent member 52 in an open configuration.

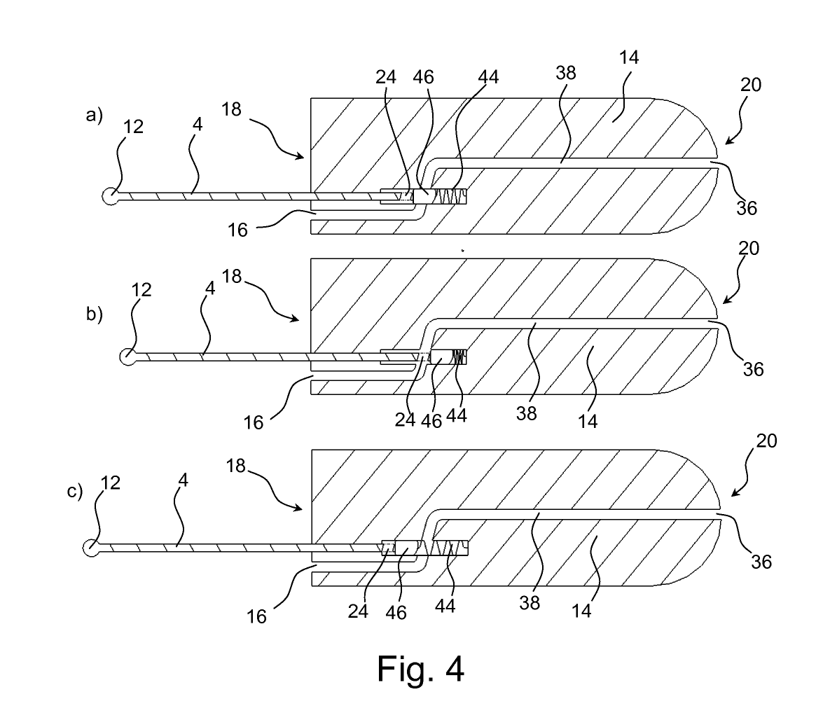

FIG. 4 illustrates three schematic cross-sectional views of a hearing aid device 2 according to an embodiment of the disclosure. FIG. 4 a), FIG. 4 b) and FIG. 4 c) illustrate different configurations of the same hearing aid device 2.

The hearing aid device 2 comprises a body member 14 and a pull out string 4 slidably arranged within a cavity provided in the body member 14. The body member 14 has a first end 18 and a second end 20 and comprises two openings, a first opening 16 and a second opening 36. A through-going canal 38 extends between the two openings 16, 20.

When the through-going canal 38 is open air can flow through the through-going canal 38. The through-going canal 38 can be opened and closed by changing the position of the pull out string 4. The pull out string 4 comprises a rod having a knob 12 attached to its distal end and a stop portion 46 provided n its opposite end.

The pull out string 4 is arranged within a pull out string canal. The pull out string canal extends parallel to the long portion of the through-going canal 38. The width of the stop portion 46 is larger than the width of the pull out string 4. Accordingly, the stop portion 46 cannot pass through the opening of the pull out string canal. Hereby the pull out string 4 is prevented from being pulled out of the hearing aid device 2.

The user of the hearing aid device 2 can use the knob 12 of the pull out string 4 to open and close the through-going canal 38. The stop portion 46 functions as a stopper. When the stop portion 46 is placed in the through-going canal 38 no air can pass through the through-going canal 38.

A spring 44 is attached to the end of the pull out string canal and to the distal end of the stop portion 46. The spring 44 is configured to pull or push the stop portion 46 back to the position indicated in FIG. 4 a).

In FIG. 4 a) the through-going canal 38 is closed by the stop portion 46. In this configuration the spring 44 is in its resting state.

In FIG. 4 b), however, the through-going canal 38 is open. The through-going bore 24 is in alignment with the through-going canal 38. Accordingly, air can flow through the through-going canal 38 from the opening 36 to the opening 16 and vice versa.

In FIG. 4 b) the pull out string 4 has been pushed towards the body member 14 into the hearing aid device 2. Hereby the spring 44 is compressed and loaded so that if the hearing aid user lets go of the pull out string 4, the spring will push the pull out string 4 to the left so that the hearing aid device 2 will be brought into the configuration shown in FIG. 4 a), in which the through-going canal 38 is in the closed.

In FIG. 4 c) the through-going canal 38 is open. The through-going bore 24 is in alignment with the through-going canal 38 and air can flow through the through-going canal 38. The pull out string 4 has to the maximum extent been pulled in the left direction out of the hearing aid device 2. Accordingly, the spring 44 has been extended beyond its resting length. When no force is applied to the pull out string 4, the spring 44 will pull back the pull out string 4 (to the right), until the spring 44 will regain its resting length and the hearing aid device 2 will be brought into a configuration corresponding to the one shown in FIG. 4 a).

FIG. 4 b) corresponds to a situation in which the pull out string 4 is applied to insert the hearing aid device into the ear canal of a heating aid user. In this situation the vent mechanism of the hearing aid device ensures that the pressure difference (over pressure) build up across the dome (not shown) during insertion of the hearing aide device 2 into the ear canal can be eliminated.

Similarly, FIG. 4 c) corresponds to a situation in which the pull out string 4 is applied to insert the hearing aid device into the ear canal of a heating aid user. In this situation the vent mechanism of the hearing aid device 2 ensures that the pressure difference build up across the dome (not shown) during insertion of the hearing aide device 2 into the ear canal can be eliminated.

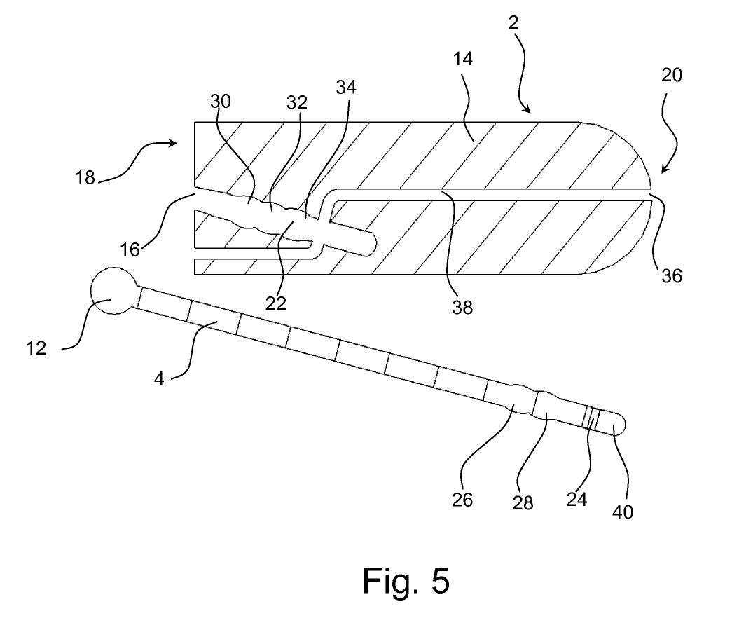

FIG. 5 illustrates a cross sectional exploded view of a hearing aid device 2 and a pull out string 4 according to an embodiment of the disclosure. The hearing aid device 2 and the pull out string 4 are separated from each other for illustration purposes.

The pull out string 4 comprises a rod-shaped portion to which a knob 12 is arranged (in the distal end). A through-going bore 24 is provided near the proximal end of the pull out string 4. The through-going bore 24 may be cylindrical or have any other suitable geometry.

The length of the through-going bore 24 corresponds to the width of the pull out string 4 and the pull out string 4 also comprises two enlarged portions 26, 28 provided at the proximal end of the pull out string 4. The two enlarged portions are of similar size and geometry and are provided adjacent to each other.

The hearing aid device 2 comprises a body member 14 provided with a pull out string canal 22 being in fluid communication with a through-going canal 38. The through-going canal 38 has two openings 16 and 36 provided at the ends 20, 18.

The pull out string canal 22 also comprises three groove members; a first groove member, a second groove member, and a third groove member. The second groove member 32 is provided between the first groove member 30 and the third groove member 34. The first groove member 30 and the second groove member 32 fit with the first enlarged portion 26 of the pull out string 4, whereas the second groove member 32 and the third groove member 34 fit the second enlarged portion 28 of the pull out string 4.

The hearing aid device shown in FIG. 5 corresponds to the one shown in FIG. 1 and in FIG. 2.

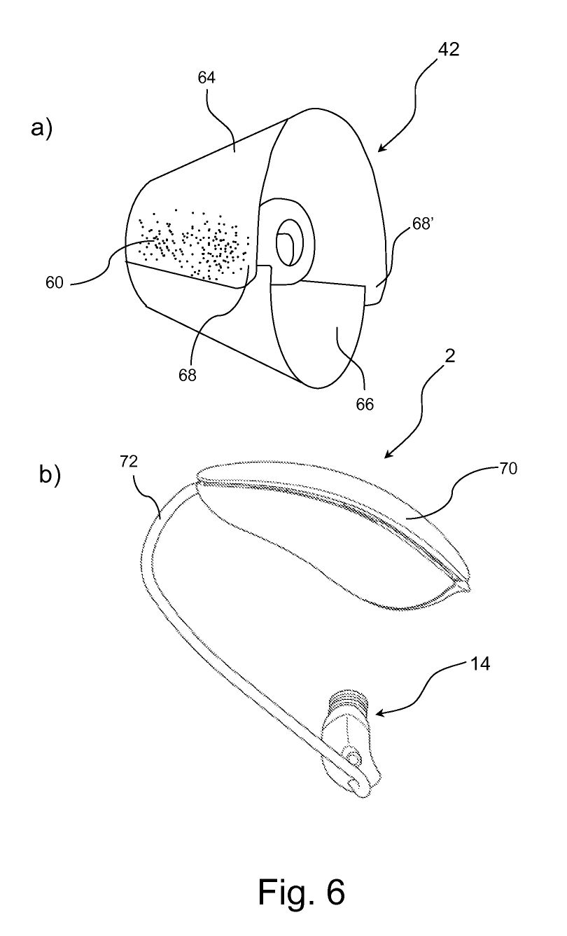

FIG. 6 illustrates a schematic view of a RITE hearing aid 2 and a corresponding tulip dome 42.

The RITE hearing aid device 2 has a body member 14 comprising a receiver. The body member 14 is connected to a housing 70 by a wire 72. The housing 70 comprises a battery, a microphone, and audio signal processing electronics including an amplifier.

The tulip dome 42 comprises a first portion 64 and a second portion 66. The first portion 64 comprises two ends 68, 68′. The first portion 64 has a small overlap at the edges with the second portion 66. The tulip dome 42 is designed to fit the ear of the user. An adhesive 60 is provided at the two ends 68, 68′. The adhesive 60 is intended to allow for firmly attach the tulip dome 42 in the ear of the hearing aid device when the hearing aid device 2 has been inserted.

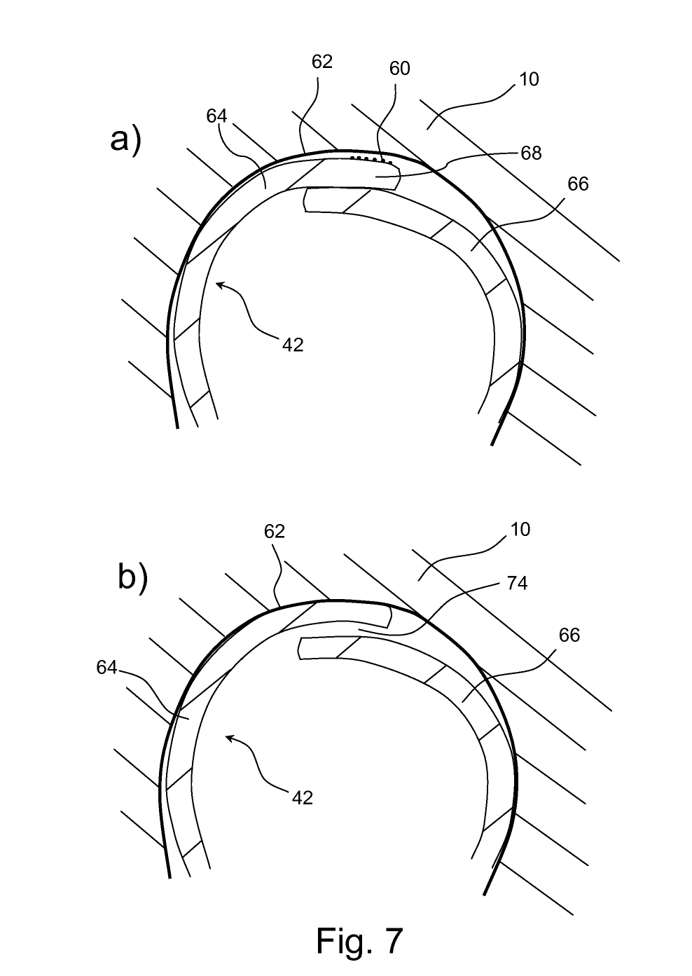

In order to remove the hearing aid device 2 from the ear 8 the tulip dome 42 may be rotated. By rotating the tulip dome 42 the second portion 66 will rotate relative to the first portion 64. Hereby a gap 74 (see FIG. 7) will be provided between the first portion 64 and the second portion 66.

The first portion 64 will not rotate due to the adhesive 60. The gap 74 (see FIG. 7) will allow air to flow into the confined space between the eardrum and the dome 42. Hereby, it is possible to equalise the pressure difference across dome 42.

FIG. 7 a) illustrates a cross sectional view of a tulip dome 42 according to an embodiment of the disclosure being inserted into the ear canal of a hearing aid user. The tulip dome 42 has a first portion 64 that slightly overlaps a second portion 66. There is no gap is between the overlapping portions 64, 66. The skin portion 62 in the ear canal 10 bears against the first portion 64 and the second portion 66. An adhesive 60 is provided at the end 68 of the first portion 64.

FIG. 7 b) illustrates a cross sectional view of the tulip dome 42 shown in FIG. 7 a). The tulip dome 42 has been rotated while being attached to the ear canal. The first portion 64 of the dome 42 is attached to the skin portion 62 of the ear canal by the adhesive (see FIG. 7 a). The rotation of the tulip dome 42 has created a gap 74 between the first portion 64 and the second portion 66.

The first portion 64 is prevented from being displaced or rotated because it is adhered to the skin portion 62 by the adhesive 60. Displacement or rotation of the second portion 66 relative to the first portion 64 will on the other hand be achieved when the dome 42 is slightly rotated. Hereby a gap 74 will be provided between the first portion 64 and the second portion 66 and this gap 74 will allow air to flow through the gap 74 in the dome 42.

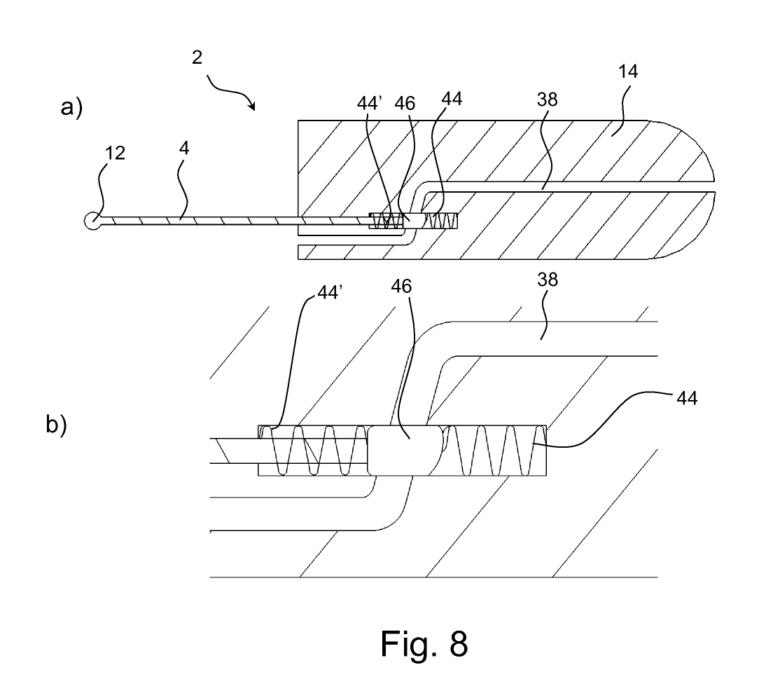

FIG. 8 a) illustrates a cross-sectional view of a hearing aid device 2 according to an embodiment of the invention. The hearing aid device 2 basically corresponds to the one illustrated in FIG. 4, however, the hearing aid device 2 shown in FIG. 8 comprises a first spring 44 and a second spring 44′ arranged to bring a stop member 46 into its resting position (as illustrated in FIG. 8 a). When the stop member 46 is brought into its resting position like shown in FIG. 8 a) the through-going canal 38 is blocked by the stop member 46.

When the pull out string 4 that is slidably mounted within a pull out string canal within the body member 14 of the hearing aid device 2, is either pushed or pulled, the stop member 46 will be displaced. Accordingly, the stop member 46 will no longer (completely) block the through-going canal 38. Thus, air can flow through the through-going canal 38 and a pressure difference across a dome (not shown) attached to the body member 14 of the hearing aid device 2 can be equalised.

FIG. 8 b) illustrates a cross-sectional close-up view of the central portion of the hearing aid device 2 shown in FIG. 8 a). It can be seen that the stop member 46 blocks the through-going canal 38 and thus preventing air to flow through the through-going canal 38.

It should be appreciated that reference throughout this specification to “one embodiment” or “an embodiment” or features included as “may” means that a particular feature, structure or characteristic described in connection with the embodiment is included in at least one embodiment of the invention. Therefore, it is emphasized and should be appreciated that two or more references to “an embodiment” or “one embodiment” or “an alternative embodiment” or features included as “may” in various portions of this specification are not necessarily all referring to the same embodiment. Furthermore, the particular features, structures or characteristics may be combined as suitable in one or more embodiments of the disclosure.

Throughout the foregoing description, for the purposes of explanation, numerous specific details such as a tulip dome, etc. were set forth in order to provide a thorough understanding of the disclosure. It will be apparent, however, to one skilled in the art that the disclosure may be practised without some of these specific details.

Accordingly, the scope of the disclosure should be judged in terms of the claims which follow.

1. A hearing aid device comprising a body member comprising a through-going canal and a receiver comprising means for attaching a dome, where the hearing aid device comprises a pull out string for inserting the body member in an ear canal and to pull out the body member from the ear canal, where the hearing aid device comprises a pull out string displaceable arranged within a pull out string canal of the body member, wherein the pull out string comprises a through-going bore and the hearing aid device comprises means for maintaining the pull out string in a first position within the pull out string canal, where in a first position the through-going canal and the through-going bore constitute a through-going vent while inserting the body member into the ear canal, and the hearing aid device comprises means for bringing and maintaining the pull out string into a second position, where in the second position the pull out string blocks the through-going canal.

2. A hearing aid device according to claim 1, wherein the pull out string comprises a first and/or second enlarged portion(s) and that the body member comprises a first groove member, and a second groove member and/or a third groove member, wherein the geometrical shape of the groove member fits the geometrical shape of the enlarged portion(s).

3. A hearing aid device according to claim 2, wherein the enlarged portion(s) is placed in the proximal half of the pull out string and that the enlarged portion(s) is arranged between the through-going bore and the distal end of the pull out string.

4. A hearing aid device according to claim 1, wherein the through-going canal has a portion that extends basically perpendicular on the pull out string canal.

5. A hearing aid device comprising a body member comprising a receiver comprising means for attachment of a dome and a through-going canal, where the hearing aid device comprises a pull out string for inserting the body member into an ear canal and to pull out the body member from the ear canal, where the hearing aid device comprises a pull out string displaceably arranged within a pull out string canal of the body member, wherein a spring is arranged in the pull out string canal in such a manner that the pull out string can be displaced such that the through-going canal is open by either pulling or pushing the pull out string.

6. A hearing aid device according to claim 5, wherein the pull out string comprises a stop portion arranged within the pull out string canal in such a manner that the stop portion blocks the through-going canal, when the spring is in its resting position.

7. A hearing aid device according claim 5, wherein the through-going canal has a portion that extends basically perpendicular on the pull out string canal.

8. A hearing aid device according to claim 6, wherein the stop portion has a wider width than the width of the pull out string.

9. A hearing aid device comprising a body member having a receiver provided with means for attachment of a dome, and a pull out string canal, where the hearing aid device comprises a pull out string for inserting the body member into an ear canal and to pull out the body member from the ear canal, where the hearing aid device comprises a pull out string displaceably arranged within a pull out string canal of the body member, wherein the dome comprises a vent opening member and an elastic and/or displaceable portion, and that the pull out string is mechanically attached to the elastic and/or displaceable portion, and that the vent opening member comprises means for being closed when no force is applied to the pull out string, and that the vent opening member comprises means for being brought into an open configuration by applying a force to the pull out string.

10. A hearing aid device according to claim 9, wherein the vent member comprises means for opening when the pull out string is pulled.

11. A hearing aid device according to claim 9, wherein the elastic portion is more elastic than the remaining portion of the dome.

12. A tulip dome for a hearing aid device, the tulip dome comprising a first portion and a second portion, wherein the tulip dome comprises means for creating a gap between the first portion and the second portion due to rotation of the tulip dome while being mounted within the ear canal, where an adhesive is provided to the first portion and/or to the second portion.

13. A tulip dome according to claim 12, wherein the properties of the adhesive are temperature dependent and/or humidity dependent.

14. A tulip dome according to claim 12, wherein the adhesive can adhere at temperatures at or above 30° C.

15. A hearing aid device comprising a tulip dome, the tulip dome comprising a first portion and a second portion, wherein the tulip dome comprises means for creating a gap between the first portion and the second portion due to rotation of the tulip dome while being mounted within the ear canal, where an adhesive is provided to the first portion and/or to the second portion.

16. The hearing aid device according to claim 15, wherein the properties of the adhesive are temperature dependent and/or humidity dependent.

17. The hearing aid device according to claim 1, further comprising a tulip dome, the tulip dome comprising a first portion and a second portion, wherein the tulip dome comprises means for creating a gap between the first portion and the second portion due to rotation of the tulip dome while being mounted within the ear canal, where an adhesive is provided to the first portion and/or to the second portion.

18. The hearing aid device according to claim 17, wherein the properties of the adhesive are temperature dependent and/or humidity dependent.
